(19) United States
(12) Patent Application Publication
(10) Pub. No.: US 2007/0162400 A1
(43) Pub. Date: Jul. 12, 2007

(54) Method and apparatus for managing digital content in a content management system

(75) Inventors: Glenn Edwards Brew, Boca Raton, FL (US); Douglas Richard Geisler, Boca Raton, FL (US); Marco M. Hurtado, Boca Raton, FL (US); James Christopher Mahlbacher, Lake Worth, FL (US); Joseph Cesare Polimeni, Parkland, FL (US); George William Wilhelm JR., Endwell, NY (US)

Correspondence Address: Sawyer Law Group LLP, P.O. Box 51418, Palo Alto, CA, 94303, US

(73) Assignee: International Business Machines Corporation, Armonk, NY (US)

(21) Appl. No.: 11/331,322

(22) Filed: Jan. 12, 2006

(51) Int. Cl. G06Q 99/00

(52) U.S. Cl. 705/59

(57) ABSTRACT

Methods and apparatus for managing rights associated with digital content in a digital exchange system (e.g., a content management system) are provided. The method includes providing one or more first templates, and providing one or more second templates. Each first template corresponds to one or more rights of a first digital rights management system, and each second template corresponds to one or more rights of a second digital rights management system. The method further includes relating one or more of the first templates to one or more of the second templates based on pre-determined criteria.

### FIELD OF THE INVENTION

The present invention relates generally to digital communications, and more particularly to digital rights management.

### BACKGROUND OF THE INVENTION

A digital exchange system (e.g., a content management system) is a system that can typically manage all types of digital information (or digital content) including, for example, HTML and XML Web content, document images, electronic office documents, printed output, audio, and video. A conventional content management system (e.g., an enterprise content management system) can generally protect digital information that is sensitive or confidential to a given business. For example, users of an enterprise content management system can declare any corporate document or information as a corporate record. Once a document is declared as a corporate record, the document cannot be edited or deleted from the enterprise content management system without proper authorization. In addition, access permissions and lifecycle of the document are governed by the access permissions and lifecycle rules defined in the enterprise content management system. Thus, only authorized users, such as the records administrators, can process or manage the life cycle of the document.

In today's growing e-business world, many businesses are finding it increasingly important to not only use an enterprise content management system to manage and store digital content generated within the given enterprise, but also to manage and import digital content generated by a user using a third party client (e.g., third party software) into the enterprise content management system. Incorporating digital content generated using third party software into an enterprise content management system is a generally straightforward process similar to incorporating digital content generated within the enterprise. Users using such third party software, however, are increasingly protecting digital content using one or more (proprietary) digital rights management (DRM) systems that are associated with the third party software. A digital rights management system generally uses applied cryptography to allow a content owner to prescribe a specific use for created content. A conventional digital rights management system is a “closed” system that does not interoperate easily with other digital rights management systems, including conventional content management systems, or non-digital rights management systems. This is a result of the fact that digital rights management systems maintain persistent control over associated digital content and if interoperability were easily achieved then content protection of the digital rights management system would be easily circumvented. Examples of digital rights management systems include Microsoft Windows® Rights Management Services (RMS) available from Microsoft Corporation of Redmond, Wash., and Adobe® LiveCycle Policy Server available from Adobe Systems Incorporated of San Jose, Calif.

One technique for integrating multiple digital rights management systems is to map rights between the multiple digital rights management systems. However, if the multiple digital rights management systems do not implement a common rights expression language, then it becomes difficult to administer the mapping of rights, especially when the rights of one digital rights management system are mutually exclusive from another digital rights management system. For example, one digital rights management system may provide for adding watermarks to printed material while another digital rights management system would restrict printing to only a trusted printer, which printer would then apply watermarks to printed pages. In this scenario, trying to equate privileges through mapping of rights becomes complicated and cumbersome.

Accordingly, what is needed is an improved method for relating rights between multiple digital rights management systems. The present invention addresses such a need.

### BRIEF SUMMARY OF THE INVENTION

In general, in one aspect, this specification describes a method for managing rights associated with digital content in a digital exchange system (e.g., a content management system). The method includes providing one or more first templates, and providing one or more second templates. Each first template corresponds to one or more rights of a first digital rights management system, and each second template corresponds to one or more rights of a second digital rights management system. The method further includes relating one or more of the first templates to one or more of the second templates based on pre-determined criteria.

Particular implementations can include one or more of the following features. Relating one or more of the first templates to one or more of the second templates can substantially maintain a same level of security among the related templates. The pre-determined criteria can be a role of a user and a classification associated with digital content. The method can further include receiving a request for digital content in the digital exchange system from a first user, in which the first user is associated with the first digital rights management system. The method can further include determining a role and classification of the first user, and protecting the digital content requested by the first user in accordance with a given first template that corresponds to the determined role and the determined classification. The method can further include receiving a request for digital content in the digital exchange system from a second user, in which the second user is associated with the second digital rights management system. The digital content requested by the second user can be the same digital content requested by the first user. The method can further include determining a role of the second user and protecting the digital content requested by the second user in accordance with a given second template that corresponds to the determined role of the second user and the determined classification.

The second user can have the same role as the first user, and the rights associated with the given first template and the rights associated with the given second template can substantially maintain a same level of security for the protected digital content. Determining a role of the first user can include determining a role of the first user based on a user identifier (ID) associated with the first user. Determining a classification of the digital content requested by the first user can include determining the classification from metadata or an attribute associated with the digital content requested by the first user. The digital content can include one or more of a digital movie, digital music, electronic book, digital broadcast, interactive game, or computer software. The method can further include receiving digital content for storage in the digital exchange system, in which the content has been previously protected in accordance with original rights associated with a given digital rights management system, and determining whether a given template exists within the digital exchange system that could maintain substantially a same level of security consistent with the original rights assigned to the received digital content. The method can further include generating an event log that can acknowledge an inconsistency of assignable rights if a template does not exist within the digital exchange system that could maintain substantially a same level of security consistent with the original rights assigned to the received digital content. The digital exchange system can be a system operable to transfer digital content from one user to another user, a content management system, an enterprise content management system, or a digital rights management system.

In general, in another aspect, this specification describes a computer program product, tangibly stored on a computer-readable medium, for managing rights associated with digital content in a digital exchange system. The product includes instructions to cause a programmable processor to provide one or more first templates, in which each first template corresponds to one or more rights of a first digital rights management system. The product further includes instructions to provide one or more second templates, in which each second template corresponds to one or more rights of a second digital rights management system, and includes instructions to relate one or more of the first templates to one or more of the second templates based on pre-determined criteria.

In general, in another aspect, this specification describes a digital exchange system for managing rights associated with digital content. The digital exchange system includes one or more first templates, in which each first template corresponds to one or more rights of a first digital rights management system. The digital exchange system further includes one or more second templates, in which each second template corresponds to one or more rights of a second digital rights management system. The digital exchange system further includes a packager operable to relate one or more of the first templates to one or more of the second templates based on pre-determined criteria.

Implementations may provide one or more of the following advantages. A content management system is disclosed that provides interoperability between multiple different (proprietary) digital rights management systems. Because the content management system can package (or protect) digital content in accordance with a set of pre-configured rights corresponding to different types of digital rights management systems, an end-user need only to have one particular type of digital rights management system that is supported by the content management system. Such transformation capability of DRM content between multiple digital rights management formats provides for improved efficiency and lower costs associated with licensing specific digital rights management software.

The details of one or more implementations are set forth in the accompanying drawings and the description below. Other features and advantages will be apparent from the description and drawings, and from the claims.

### BRIEF DESCRIPTION OF SEVERAL VIEWS OF THE DRAWINGS

FIG. 1 is a block diagram of a data processing system including a content management system in accordance with one implementation of the invention.

FIG. 2 is a block diagram illustrating the content management system of FIG. 1 in accordance with one implementation of the invention.

FIG. 3 illustrates a method for retrieving digital content from the content management system of FIG. 1 in accordance with one implementation of the invention.

FIG. 4 illustrates a block diagram of a content management system in accordance with one implementation of the invention.

FIG. 5 is a block diagram of a data processing system suitable for storing and/or executing program code in accordance with one implementation of the invention.

Like reference symbols in the various drawings indicate like elements.

### DETAILED DESCRIPTION OF THE INVENTION

Implementations of the present invention relates generally to digital communications, and more particularly to digital rights management. The following description is presented to enable one of ordinary skill in the art to make and use the invention and is provided in the context of a patent application and its requirements. Various modifications to implementations and the generic principles and features described herein will be readily apparent to those skilled in the art. Thus, the present invention is not intended to be limited to the implementations shown but is to be accorded the widest scope consistent with the principles and features described herein.

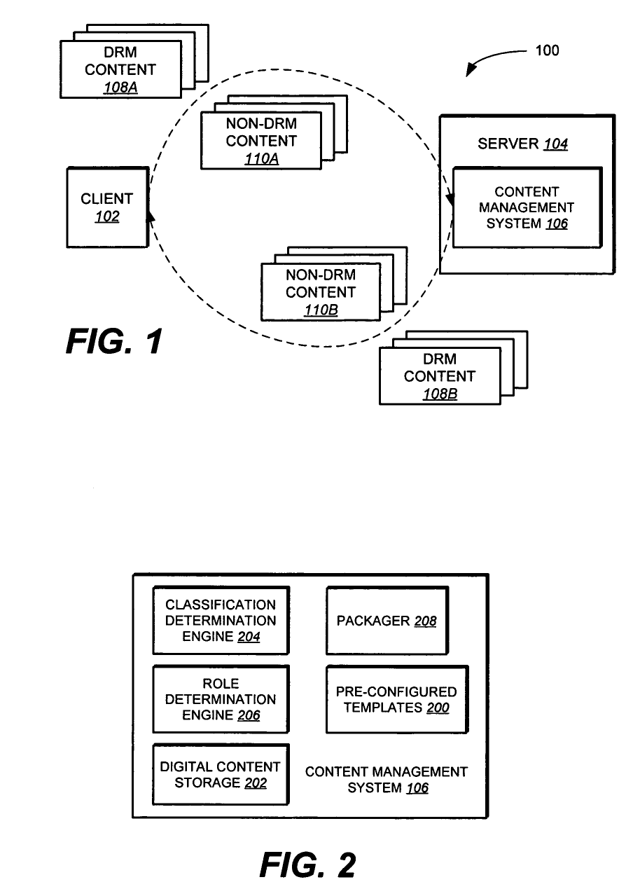

FIG. 1 illustrates a data processing system 100 including a client 102 and a server 104 in accordance with one implementation of the invention. Although data processing system 100 is shown as including one client and one server, data processing system 100 can include any number of clients and servers. Data processing system 100 can comprise be any number and type of computer systems, including for example, a workstation, a desktop computer, a laptop computer, a personal digital assistant (PDA), a cell phone, a network, and so on. Data processing system 100 includes a content management system 106 that (in one implementation) is stored on server 104. Content management system 106 can be a an enterprise software solution, such as an enterprise content management system as described in contemporaneously filed U.S. patent application—“Method and Apparatus for Providing Interoperability Between Digital Rights Management Systems”, attorney docket no. SVL920050095US1/3661P, which is incorporated by reference in its entirety. More generally, content management system 106 can be any type of digital exchange system that can exchange (or transfer) digital content from one user to another user.

In one implementation, content management system 106 relates combinations of rights between multiple digital rights management systems that may implement different rights expression languages. In general, a rights expression language is intended to provide mechanisms to support augmented use of digital resources in publishing, distributing, and consuming of digital content—e.g., digital movies, digital music, electronic books, broadcasting, interactive games, computer software and other creations in digital form—in a way that protects the digital content and enforces, for example, the rights, conditions, and/or fees specified for the digital content. That is, rights expression languages can be used to provide access control to digital content. A common concept in access control systems is that of a role and a classification. A role specifies types of users (e.g., managers, engineers, attorneys, and so on) of a digital rights management system, and a classification specifies a level of protection to be associated with specific digital content (e.g., non-confidential, confidential, classified, secret, and so on).

In one implementation, content management system 106 includes a plurality of templates (not shown). In one implementation, each template associates a set of pre-configured rights based on pre-determined criteria (e.g., a role and classification combination) for each digital rights management system (known to content management system 106). In another implementation, each template corresponds to (or bundles) one or more rights of a given digital rights management system (known to content management system 106) and, therefore, content management system 106 will contain a plurality of templates for each supported digital rights management system. The templates can be pre-configured by, e.g., an administrator or other user, or by content management system 106 itself. For example, given a role “manager”, and a classification of “confidential”, an administrator can pre-configure (or bundle) a set of rights to be applied to specific digital content for each digital rights management system supported by content management system 106. In this example, a set of rights that may be applied to specific digital content (for a manager) based on a first digital rights management system is that a digital watermark will be applied to digital content that is printed, whereas a set of rights that may be applied to the same classification and role based on a second digital rights management system is that the digital content can only be printed by a manager to a trusted printer, which trusted printer adds a digital watermark to all printed documents. Thus, even though the mapping of specific, individual rights may not be equivalent (i.e., the former applies digital watermarks and the latter relies on a printer to apply watermarks), content management system 106 automatically determines that two or more bundles of rights, based on classification and roles, are related (or substantially equivalent) to achieve a desired level of security.

FIG. 2 illustrates one implementation of content management system 106 in greater detail. As shown in FIG. 2, content management system 106 includes a plurality of pre-configured templates 200, digital content storage 202, a classification determination engine 204, a role determination engine 206, and a packager 208.

In one implementation, pre-configured templates 200 represent a plurality of templates in which each template associates a set of rights based on one or more pre-determined criteria. In one implementation, the pre-determined criteria include a particular role and classification combination. These sets of rights can be applied as appropriate to specific digital content, as discussed in greater detail below, to control the use of the specific digital content and achieve the policy defined by the template. A policy includes one or more rights that govern the interaction between a user and digital content. The plurality of templates can be pre-configured by, e.g., an administrator or other user. In one implementation, if a particular digital rights management system does not contain a set of rights to achieve a level of protection required for a given role/classification policy, then a set of rights for the particular digital rights management system is not defined within the template corresponding to the given role/classification policy. Alternatively, in an implementation in which each template corresponds to a bundled set of rights, if a particular digital rights management system does not contain a set of rights to achieve a level of protection required for a given role/classification policy then a template for the particular digital rights management system does not exist.

Digital content storage 202 is a repository for digital content. Referring back to FIG. 1, content management system 106 can receive protected digital content (e.g., DRM content 108A) and/or non-protected digital content (e.g., non-DRM content 110A) and export protected digital content (e.g., DRM content 108B) and/or non-protected digital content (e.g., non-DRM content 110B). Accordingly, content management system 106 can receive and store digital content in a plurality of different digital rights management formats.

In one implementation, classification determination engine 204 determines a classification associated with digital content stored in digital content storage 202. In one implementation, the digital content stored in digital content storage 202 includes associated metadata or attributes that can be used to determine a classification of the digital content. For example, different types of classification can include, for example, non-confidential, confidential, classified, secret, top-secret, and so on. The classification of digital content can be specified by a user.

In one implementation, role determination engine 206 determines a role associated with a user requesting digital content from digital content storage 202. The role of a user can be determined from attributes associated with the user or the user's identification (ID). For example, when integrating access control list (ACL) based policies, the role of a user can be determined (or implied) from the subject (associated with a given ACL policy). The subject generally identifies the user that is requesting digital content as being associated with a group (e.g., a group of managers). Different types of roles include, for example, managers, engineers, attorneys, doctors, assistants, staff, and so on.

In one implementation, packager 208 packages digital content (requested by a user) in accordance with pre-configured rights of a template corresponding to determined role of the user and the determined classification of the digital content. Thus, for example, if a manager using a first digital rights management system requests confidential digital content from digital content storage 202, then packager 208 will package the requested digital content, for example, such that a digital watermark will be applied to a printed page representing the digital content. Additionally, if a different manager using a second digital rights management system requests the same confidential digital content from digital content storage 202, then packager 208 will, for example, package the requested digital content such that the digital content can only be printed to a trusted printer, which trusted printer applies a digital watermark to printed pages. Accordingly, digital content may be retrieved from in digital content storage 202 in a plurality of different digital rights management formats, and achieve substantially a same level of protection for digital content. In one implementation, packager 208 is further operable to relate one or more templates to one another such that the related templates provide substantially the same level of protection when applied to digital content. In one implementation, the digital content is packaged and/or unpackaged in accordance with pre-established credentials (or rights) established with digital rights management systems supported by content management system 106. More specifically, the pre-established credentials give content management system 106 one or more ownership rights in the digital content imported into the content management system. Consequently, in this implementation, content management system 106 can have the authority to unpackage and/or package digital content based according to needs of users.

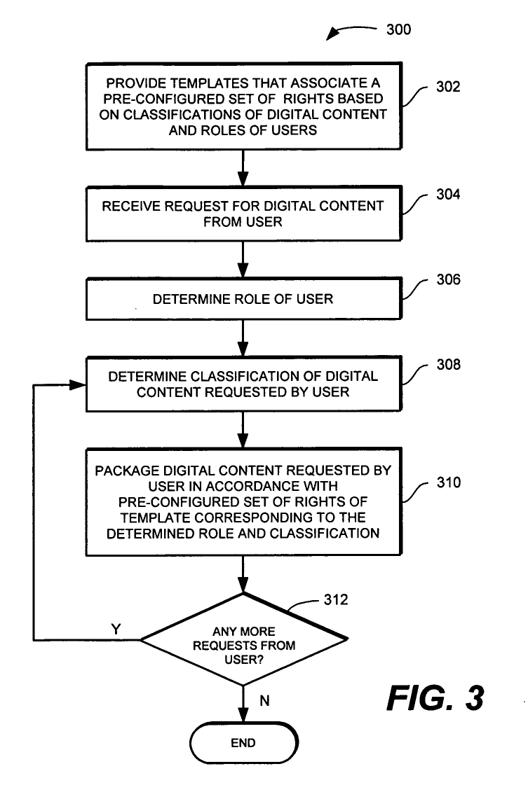

FIG. 3 illustrates one implementation of a method 300 for retrieving digital content from a content management system (e.g., content management system 106). A plurality of templates are provided that associates a pre-configured set of rights based on, for example, classifications of digital content and roles of users (step 302). In one implementation, the sets of rights are pre-configured by an administrator or other user. Each template can correspond to a particular role/classification combination, and can specify a bundle of rights that apply to each digital rights management system supported by the content management system. More generally, the plurality of templates can bundle a set of rights according to any pre-determined criteria, including for example, criteria based on location (e.g., a location of a user or of specific digital content), date or time (e.g., a day or time that digital content was created), purpose (e.g., a specific purpose for which digital content was created), and so on. Accordingly, a plurality of templates can be provided, for example, that associates a pre-configured set of rights based on locations of one or more users. A request for digital content from the content management system is received (step 304). In one implementation, the request includes a request for digital content in a format specific to a particular digital rights management system. Alternatively, the content management system can determine a particular digital rights management format required by the user through information associated with a user ID or user account of the user.

A role of the user is determined (e.g., by role determination engine 206) (step 306). The role of the user can be determined from information associated with a user ID or user account of the user. For example, the user ID of the user may belong to a particular group from which the role of the user can be implied. A classification of the digital content requested by the user is determined (e.g., by classification determination engine 204) (step 308). The classification of the digital content can be determined by metadata or attributes associated with the digital content. The digital content requested by the user is packaged (e.g., by packager 208) in accordance with a pre-configured set of rights of a template corresponding to determined role and classification (step 310). The packaged digital content is then exported from the content management system to the user. Thus, digital rights management interoperability is provided through a content management system that relates one or more rights between multiple digital rights management systems based on, for example, roles and classifications that achieve a common (desired) level of security. As discussed above, criteria other than roles and classifications can be used to relate one or more rights between multiple digital rights management systems.

A determination is made as to whether there are any more requests for digital content by the user (step 312). If there are more requests from the user, then the method returns to step 308 to determine, for example, a classification of the requested digital content, otherwise, the method ends.

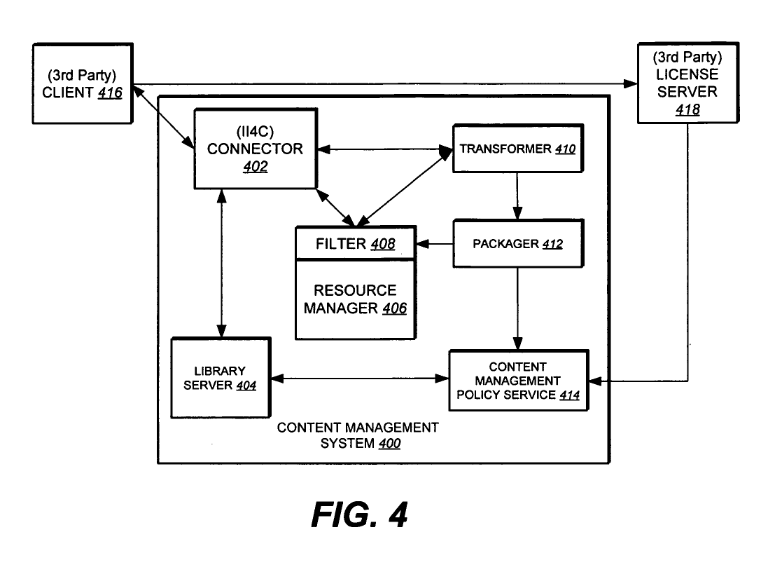

FIG. 4 illustrates another implementation of a content management system 400 in accordance with one implementation of the present invention. As shown in FIG. 4, enterprise content management system 400 includes a connector 402, a library server 404, and a resource manager 406.

In one implementation, connector 402 is an Information Integrator for Content (II4C) connector that provides broad information integration for enterprise portals, relational databases, business intelligence, and enterprise content management applications. The II4C connector lets (business) users personalize data queries, search extensively for very specific needs, and utilize relevant results across both traditional and multimedia data sources. For developers, the II4C connector enables rapid portal application development and deployment. The II4C connector additionally provides an enhanced foundation for access to both structured data (stored in library server 404) and unstructured data (stored in resource manager 406). In one implementation, connector 402 comprises a set of application programming interfaces (APIs) (e.g., in JAVA or C) that permits a user to interact with library server 404 and resource manager 406. Examples of unstructured data that can be stored in resource manager 406 include JPEG (Joint Photographic Experts Group) images and BMP (bitmap) images, and examples of structured data that can be stored in library server 404 include references, attributes, and/or metadata associated with the JPEG images and BMP images stored in resource manager 406. Generally, connector 402 isolates library server 404 from resource manager 406, and provides a means for permitting users to manage (e.g., retrieve, import, update, or remove) digital content within content management system 400.

Content management system 400 further includes a filter 408, a transformer 410, a packager 412, and a content management policy service 414. In one implementation, filter 408 intercepts a user request from a client 416 for digital content (stored in resource manager 406) so that transformer 410 can call packager 412 to package (or protect) the requested digital content. In one implementation, transformer 410 determines what transformations should be applied to digital content as digital content is imported and exported from content management system 400. For example, DRM content (in accordance with a first digital rights management format) received by content management system 400 may need to be stored according to a second digital rights management format as specified by content management policy service 414. Also, digital content stored within content management system 400 may need to be transformed to a particular digital rights management format associated with a particular user. In one implementation, transformer 410 maintains a list of digital rights management systems associated with each user (or client) of content management system 400 (e.g., in a content ID repository). In this implementation, when digital content is exported from content management system 400 to a particular user, transformer 410 can determine what types of transformations need to be performed on digital content based on a current state of the digital content and a digital right management format required by the particular user. Transformer 410 can negotiate with a license server of a particular digital rights management system (e.g., a third party license server) to unprotect (or unpackage) or protect digital content imported into content management system 400.

During the packaging of the digital content, content management policy service 414 queries library server 404 for metadata associated with the requested digital content. The metadata can include rights and privileges associated with the requested digital content. In one implementation, library server 404 responds to the query with a classification and one or more roles based, respectively, on the rights and privileges associated with the requested digital content and information associated with the user. In this implementation, packager 412 then packages the requested digital content in accordance with a pre-configured set of rights corresponding to the one or more roles and the classification. In one implementation, packager 412 can package digital content in accordance with many different digital rights management systems (represented in FIG. 4 by third party license server 418). Accordingly, content management system 400 is operable to assign a pre-configured set of rights to digital content for any digital rights management system. The assignment of rights can be such that a desired level of security is maintained for digital content.

In one implementation, content management system 400 further includes mechanisms to ensure that policies of (third party) digital rights management systems are maintained by content management system 400. In this implementation, when a user imports DRM content (e.g., protected digital content) into content management system 400 (e.g., through third party client 416), filter 408 intercepts the digital content and determines that the digital content has been previously protected and that rights have been assigned to the digital content. Filter 408 calls appropriate extensions and verifies that the original (third party) rights associated with the digital content are consistent with policies and rights of content management system 400.

In one implementation, filter 408 determines whether a template exists that contains a pre-configured set of rights that can maintain substantially the same level of security consistent with the original third party policy rights. If such a template does not exist that can maintain the substantially the same level of security consistent with the original third party policy rights, then corrective action is taken. In one implementation, content management system 400 generates an event log or dialog at a console that signals the need for human intervention to, for example, reassign or create new policies and rights that are consistent with the original third party policy rights. In one implementation, the generated event log acknowledges an inconsistency of assignable rights if a template does not exist within the digital exchange system that can maintain substantially a same level of security consistent with the original third party policy rights assigned to the received digital content. The event logs generated by content management system 400 can be monitored by an auditing service to ensure that policies are being enforced and maintained by content management system 400.

One or more of method steps described above can be performed by one or more programmable processors executing a computer program to perform functions by operating on input data and generating output. Generally, the invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

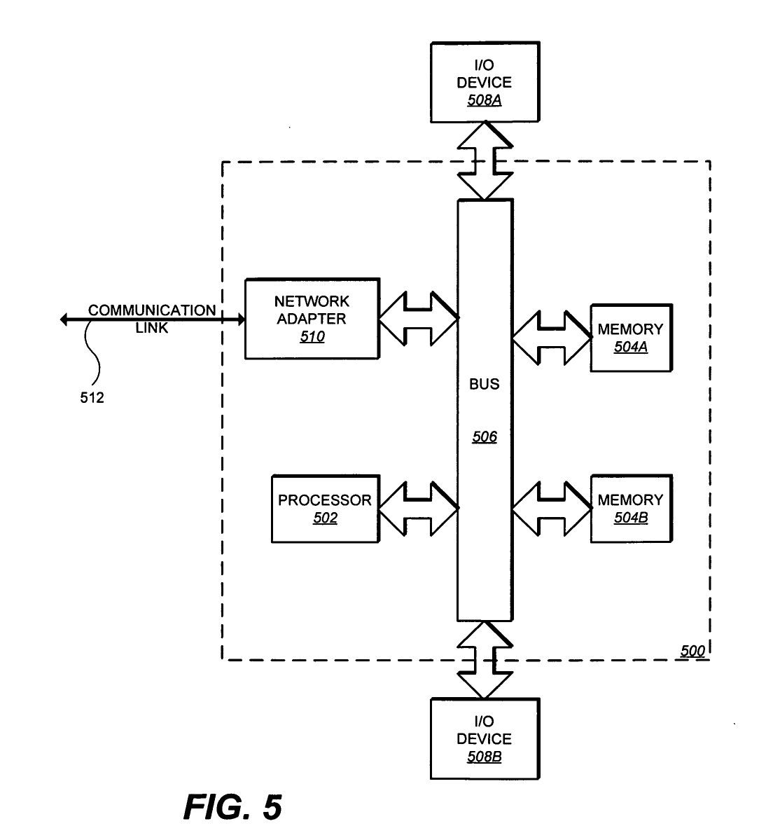

FIG. 5 illustrates a data processing system 500 suitable for storing and/or executing program code. Data processing system 500 includes a processor 502 coupled to memory elements 504A-B through a system bus 506. In other embodiments, data processing system 500 may include more than one processor and each processor may be coupled directly or indirectly to one or more memory elements through a system bus.

Memory elements 504A-B can include local memory employed during actual execution of the program code, bulk storage, and cache memories that provide temporary storage of at least some program code in order to reduce the number of times the code must be retrieved from bulk storage during execution. As shown, input/output or I/O devices 508A-B (including, but not limited to, keyboards, displays, pointing devices, etc.) are coupled to data processing system 500. I/O devices 508A-B may be coupled to data processing system 500 directly or indirectly through intervening I/O controllers (not shown).

In the embodiment, a network adapter 510 is coupled to data processing system 500 to enable data processing system 500 to become coupled to other data processing systems or remote printers or storage devices through communication link 512. Communication link 512 can be a private or public network. Modems, cable modems, and Ethernet cards are just a few of the currently available types of network adapters.

Various implementations for managing digital content in a content management system have been described. Nevertheless, one or ordinary skill in the art will readily recognize that there that various modifications may be made to the implementations, and any variation would be within the scope of the present invention. For example, the steps of methods discussed above can be performed in a different order to achieve desirable results. In addition, the pre-determined criteria by which a template bundles a set of rights can be based on any criteria other than roles and/or classifications, such as criteria based on location, time, date, purpose, and so on. Accordingly, many modifications may be made by one of ordinary skill in the art without departing from the scope of the following claims.

What is claimed is:

1. A method for managing rights associated with digital content in a digital exchange system, the method comprising:
providing one or more first templates, wherein each first template corresponds to one or more rights of a first digital rights management system;
providing one or more second templates, wherein each second template corresponds to one or more rights of a second digital rights management system; and
relating one or more of the first templates to one or more of the second templates based on pre-determined criteria.

2. The method of claim 1, wherein relating one or more of the first templates to one or more of the second templates substantially maintains a same level of security among the related templates.

3. The method of claim 2, wherein the pre-determined criteria comprise a role of a user and a classification associated with digital content.

4. The method of claim 3, further comprising:
receiving a request for digital content in the digital exchange system from a first user, the first user being associated with the first digital rights management system;
determining a role of the first user, and determining a classification of the digital content requested by the first user; and
protecting the digital content requested by the first user in accordance with a given first template that corresponds to the determined role and the determined classification.

5. The method of claim 4, further comprising:
receiving a request for digital content in the digital exchange system from a second user, the second user being associated with the second digital rights management system, wherein the digital content requested by the second user is the same digital content requested by the first user;
determining a role of the second user; and
protecting the digital content requested by the second user in accordance with a given second template that corresponds to the determined role of the second user and the determined classification.

6. The method of claim 5, wherein if the second user has a same role as the first user, then the rights associated with the given first template and the rights associated with the given second template substantially maintain a same level of security for the protected digital content.

7. The method of claim 4, wherein determining a role of the first user includes determining a role of the first user based on a user identifier (ID) associated with the first user.

8. The method of claim 4, wherein determining a classification of the digital content requested by the first user includes determining the classification from metadata or an attribute associated with the digital content requested by the first user.

9. The method of claim 4, wherein the digital content comprises one or more of a digital movie, digital music, electronic book, digital broadcast, interactive game, or computer software.

10. The method of claim 1, further comprising:
receiving digital content for storage in the digital exchange system, the digital content having been previously protected in accordance with original rights associated with a given digital rights management system;
determining whether a given template exists within the digital exchange system that can maintain substantially a same level of security consistent with the original rights assigned to the received digital content; and
generating an event log that acknowledges an inconsistency of assignable rights if a template does not exist within the digital exchange system that can maintain substantially a same level of security consistent with the original rights assigned to the received digital content.

11. The method of claim 1, wherein the digital exchange system comprises a system operable to transfer digital content from one user to another user.

12. The method of claim 11, wherein the digital exchange system comprises one of a content management system, an enterprise content management system, or a digital rights management system.

13. A computer program product, tangibly stored on a computer-readable medium, for managing rights associated with digital content in a digital exchange system, the product comprising instructions to cause a programmable processor to:
provide one or more first templates, wherein each first template corresponds to one or more rights of a first digital rights management system;
provide one or more second templates, wherein each second template corresponds to one or more rights of a second digital rights management system; and
relate one or more of the first templates to one or more of the second templates based on pre-determined criteria.

14. The product of claim 13, wherein the instructions to relate one or more of the first templates to one or more of the second templates include instructions to relate one or more of the first templates to one or more of the second templates to substantially maintain a same level of security among the related templates.

15. The product of claim 14, wherein the pre-determined criteria comprise a role of a user and a classification associated with digital content.

16. The product of claim 15, further comprising instructions to cause a programmable processor to:
receive a request for digital content in the digital exchange system from a first user, the first user being associated with the first digital rights management system;
determine a role of the first user, and determining a classification of the digital content requested by the first user; and
protect the digital content requested by the first user in accordance with a given first template that corresponds to the determined role and the determined classification.

17. The product of claim 16, further comprising instructions to cause a programmable processor to:
receive a request for digital content in the digital exchange system from a second user, the second user being associated with the second digital rights management system, wherein the digital content requested by the second user is the same digital content requested by the first user;
determine a role of the second user; and
protect the digital content requested by the second user in accordance with a given second template that corresponds to the determined role of the second user and the determined classification.

18. The product of claim 17, wherein if the second user has a same role as the first user, then the rights associated with the given first template and the rights associated with the given second template substantially maintain a same level of security for the protected digital content.

19. The product of claim 16, wherein the instructions to determine a role of the first user include instructions to determine a role of the first user based on a user identifier (ID) associated with the first user.

20. The product of claim 16, wherein the instructions to determine a classification of the digital content requested by the first user include instructions to determine the classification from metadata or an attribute associated with the digital content requested by the first user.

21. The product of claim 16, wherein the digital content comprises one or more of a digital movie, digital music, electronic book, digital broadcast, interactive game, or computer software.

22. The product of claim 13, further comprising instructions operable to cause a programmable processor to:
receive digital content for storage in the digital exchange system, the digital content having been previously protected in accordance with original rights associated with a given digital rights management system;
determine whether a given template exists within the digital exchange system that can maintain substantially a same level of security consistent with the original rights assigned to the received digital content; and
generate an event log that acknowledges an inconsistency of assignable rights if a template does not exist within the digital exchange system that can maintain substantially a same level of security consistent with the original rights assigned to the received digital content.

23. The product of claim 13, wherein the digital exchange system comprises a system operable to transfer digital content from one user to another user.

24. The product of claim 23, wherein the digital exchange system comprises one of a content management system, an enterprise content management system, or a digital rights management system.

25. A digital exchange system for managing rights associated with digital content, the digital exchange system comprising:
one or more first templates, wherein each first template corresponds to one or more rights of a first digital rights management system;
one or more second templates, wherein each second template corresponds to one or more rights of a second digital rights management system; and
a packager operable to relate one or more of the first templates to one or more of the second templates based on pre-determined criteria.

26. The digital exchange system of claim 25, wherein the packager is operable to relate one or more of the first templates to one or more of the second templates to substantially maintain a same level of security among the related templates.

27. The digital exchange system of claim 26, wherein the pre-determined criteria comprise a role of a user and a classification associated with digital content.

28. The digital exchange system of claim 27, further comprising:
a role determination engine operable to determine a role of a user that has requested digital content from the digital exchange system, the user being associated with the first digital rights management system; and
a classification determination engine operable to determine a classification of the digital content requested by the user,
wherein the packager is further operable to protect the digital content requested by the user in accordance with a given first template that corresponds to the determined role and the determined classification.

29. The digital exchange system of claim 28, wherein the role determination engine is operable to determine a role of the user based on a user identifier (ID) associated with the user.

30. The digital exchange system of claim 28, wherein the classification determination engine is operable to determine the classification of the digital content requested by the user based on metadata or an attribute associated with the digital content requested by the user.

31. The digital exchange system of claim 28, wherein the digital content requested by the user comprises one or more of a digital movie, digital music, electronic book, digital broadcast, interactive game, or computer software.

32. The digital exchange system of claim 25, wherein the digital exchange system comprises a system operable to transfer digital content from one user to another user.

33. The digital exchange system of claim 32, wherein the digital exchange system comprises one of a content management system, an enterprise content management system, or a digital rights management system.
